(19) United States
(12) Patent Application Publication
(10) Pub. No.: US 2024/0223856 A1
(43) Pub. Date: Jul. 4, 2024

(54) MASKING INFORMATION FOR STRUCTURED APPLICATIONS

(71) Applicant: International Business Machines Corporation, Armonk, NY (US)

(72) Inventors: Steve RIDGILL, Raleigh, NC (US); Randy A. RENDAHL, Raleigh, NC (US); Aditya MANDHARE, Durham, NC (US); Zach TAYLOR, Fuquay Varina, NC (US)

(21) Appl. No.: 18/148,426

(22) Filed: Dec. 29, 2022

(51) Int. Cl. H04N 21/4545; G06F 3/14

(52) U.S. Cl. CPC H04N 21/45455; G06F 3/1454

(57) ABSTRACT

Masking sensitive information in a shared display is described herein. For example, system level detection of a shared display condition and application specific privacy settings are used to identify sensitive information and obscures a visual presentation of the contents on a shared system display.

### BACKGROUND

The present disclosure relates to providing privacy for sensitive information visually presented on publicly viewed displays, and more specifically, to preventing sensitive or private information from being publicly viewed in certain situations.

As more communication between people transitions to virtual communication via web or video conferencing applications, the amount and type of information that may be presented to viewers of a video conferences increases. For example, many video conferencing applications include options to share a display of a computer screen or content of an application running on a computer to the viewers of the video conference. This feature allows for viewers to follow along with a presenting user as they view and interact with an application or other content running on a computing system. However, in some cases, the user may inadvertently display and share sensitive information, including private information such as passwords, confidential information, or other information not meant for general viewing, in the video conference. While some video conferencing applications provide some methods to prevent sharing sensitive information, providing a system that ensures that sensitive information is not inadvertently displayed on shared displays remains a challenge.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method includes detecting, at a privacy application for a system, a system display associated with a user is in a shared condition, detecting a first item associated with a first application running on the system is visually presented on the system display, and determining from privacy settings for the first application a privacy screening condition for the first item. The method also includes masking the first item according to the privacy screening condition to obscure the visual presentation of contents of first item on the system display in the shared condition. Other embodiments of this aspect include corresponding computer systems, apparatus, and computer programs recorded on one or more computer storage devices, each configured to perform the actions of the methods.

One example embodiment includes a system. The system includes a computer processor and a memory containing a program which when executed by the computer processor performs an operation. The operation includes detecting, at a privacy application for a system, a system display associated with a user is in a shared condition, detecting a first item associated with a first application running on the system is visually presented on the system display, determining from privacy settings for the first application a privacy screening condition for the first item, and masking the first item according to the privacy screening condition to obscure the visual presentation of contents of first item on the system display in the shared condition.

One example embodiment includes a computer program product including a computer-readable storage medium having computer-readable program code embodied therewith, the computer-readable program code executable by one or more computer processors to perform an operation. The operation includes detecting, at a privacy application for a system, a system display associated with a user is in a shared condition, detecting a first item associated with a first application running on the system is visually presented on the system display, determining from privacy settings for the first application a privacy screening condition for the first item, and masking the first item according to the privacy screening condition to obscure the visual presentation of contents of first item on the system display in the shared condition.

### BRIEF DESCRIPTION OF THE SEVERAL VIEWS OF THE DRAWINGS

FIG. 1 illustrates a networked display system 100, according to one embodiment.

FIGS. 2A-D illustrates sensitive information in an application on shared displays, according to various embodiments.

FIGS. 3A-D illustrates sensitive information in multiple applications on shared displays, according to various embodiments.

FIGS. 4A-B illustrates sensitive information on shared displays with a masking confirmation, according to various embodiments.

FIG. 5 illustrates an application with sensitive information tags, according to an embodiment.

FIG. 6 is a method for masking sensitive information in a networked display system, according to embodiments described herein.

FIG. 7 illustrates a block diagram of a system with a privacy application, according to one embodiment.

### DETAILED DESCRIPTION

As described above, video communication is an increasing part of professional, personal, and commercial communication. As companies increasingly rely on remote workers or workers across geographically dispersed locations, many day to day meetings and other communication has shifted to video conferencing via video conferencing applications. As users interact, they often share content via video conferences including both sharing an entire screen/display and specific applications or content. Additionally, people increasingly work in public places, such as coffee shops, shared workings spaces or other open workspace areas where a computer's display may be viewed by various other physical viewers.

In any of these examples, a user may share or display information that is sensitive in nature, which would otherwise not be shared with external viewers. Some video conferencing programs and computing systems offer various mechanisms to pause sharing or attempt to prevent sharing of sensitive information; however, users often briefly share information before taking manual steps to remove the visual presentation of the sensitive information from a shared display or do not realize they are sharing the information. In some cases, such as screen capture and screen recording, even brief displays of sensitive information may cause the information to be permanently accessible to unwanted parties or viewers.

The methods and systems described herein allow for a seamless sharing of content from a user's system without inadvertent displays of sensitive information. The systems and methods described herein provides a system level detection of a shared condition and application specific privacy settings to mask identified sensitive information which obscures the visual presentation of the contents on a shared system display.

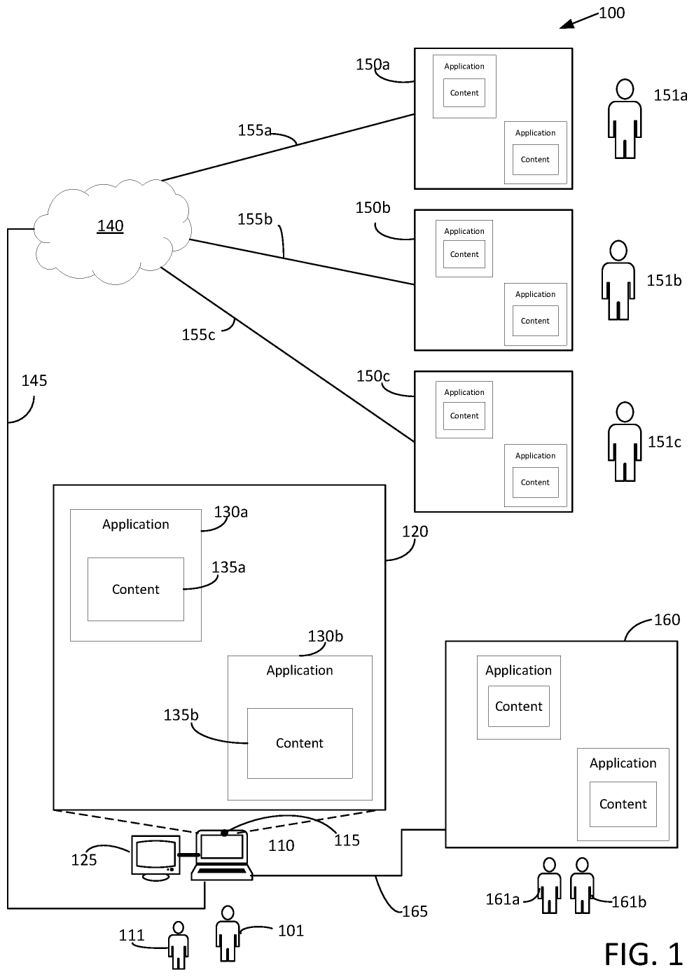

FIG. 1 illustrates a networked display system 100, according to one embodiment. The display system 100 includes a system 110 which includes a user display 120, shown in an expanded view in FIG. 1. The system 110 and includes various computer programs or applications, such as applications 130a and 130b executing on the various resources of the system 110. The applications 130a and 130b also include visual presentations including content items 135a and 135b visually presented on the user display 120. For example, applications 130a and 130b may include any type of user interactive application with a guided user interface (GUI) or other user facing content for visual consumption of a user of the system 110, such as user 101. In some examples, the user 101 views the user display 120 via a local display of the system 110 (e.g. a computer monitor) or an associated display 125 (e.g., an additional monitor or remote display) which extends or mirrors the user display 120 on the on the display 125. In some examples, the display 125 and the user display 120 are physically viewed only by the user 101.

As discussed above, the user 101 may share the information and content visually presented on their local systems via external displays, such as a local external display 160 and remote external displays 150a-150c. In some examples, the external display 160 may include a display system, such as projection system or other monitor/display viewable by multiple viewers. The external display 160 may be connect to the system 110 via a local connection 165 (e.g., a wired, wireless, or other direct connection). In some examples, viewers 161a and 161b view the applications 130a-b and content 135a-b presented on the user display 120 via the external display 160.

The external displays 150a-150c also display the applications 130a-b and content 135a-b to respective viewers 151a-c. The external displays 150a-150c are connected to the system 110 via network 140 and networked connections 145 and 155a-c. For example, the network 140 may be any type of wide network including public networks such as the Internet, where the system 110 and the external displays 150a-c communicate via the network 140. In some examples, the external displays 150a-150c may including computing systems associated with the various viewers 151a-151c or other displays or monitors where viewers 151a-151c view the applications 130a-b and content 135a-b presented on the user display 120 via the external displays 150a-150c.

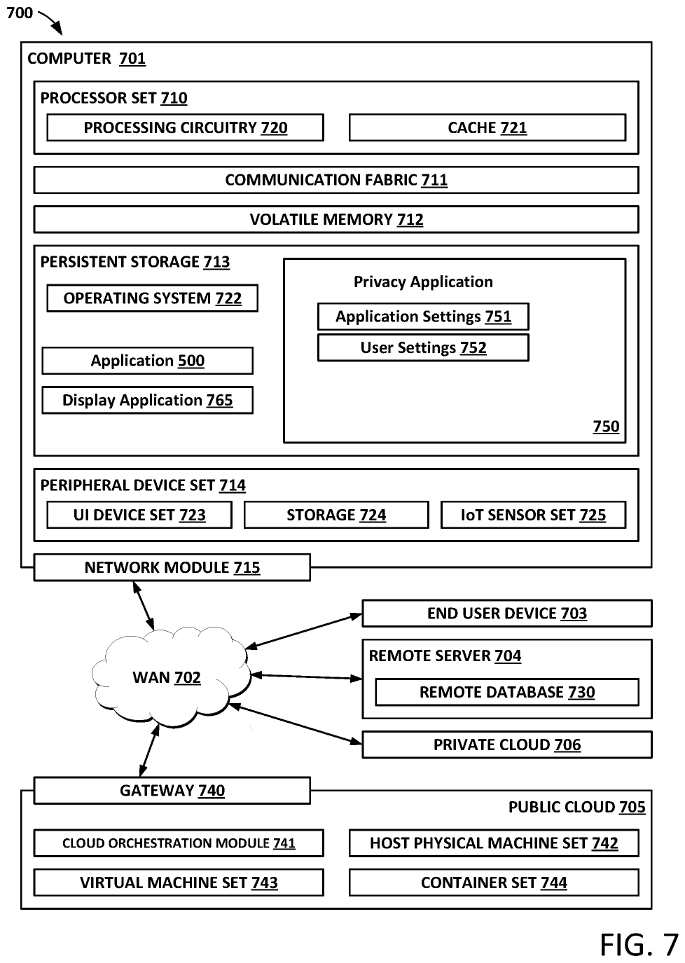

In some examples, the user 101 may be the only physical viewer of the user display 120 or the display 125 of the system 110; however, in some cases, additional viewers, such as viewer 111 may be able to view the contents presented on the display, such that the information shown on the user display 120 is not private to the user 101. In some examples, the system 110 includes a sensor 115 (e.g., a camera or other presence detection sensor), which detects the presence of the user and viewer 111. In this example, the system 110, using a privacy application, such as privacy application 750 shown in FIG. 7, and the sensor 115 detects that the user display 120 is in a shared condition even if not shared to the various other external displays 150a-150c and 160.

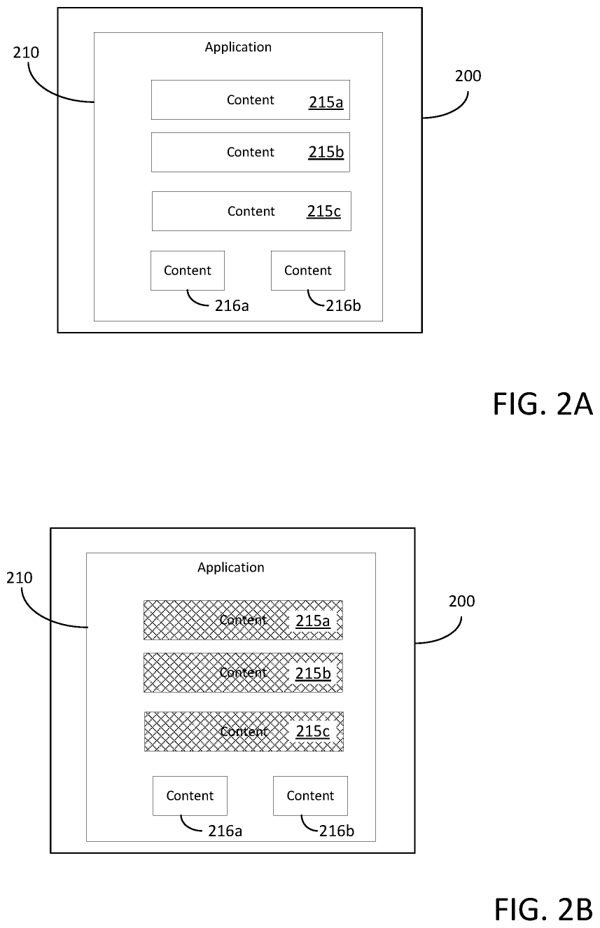

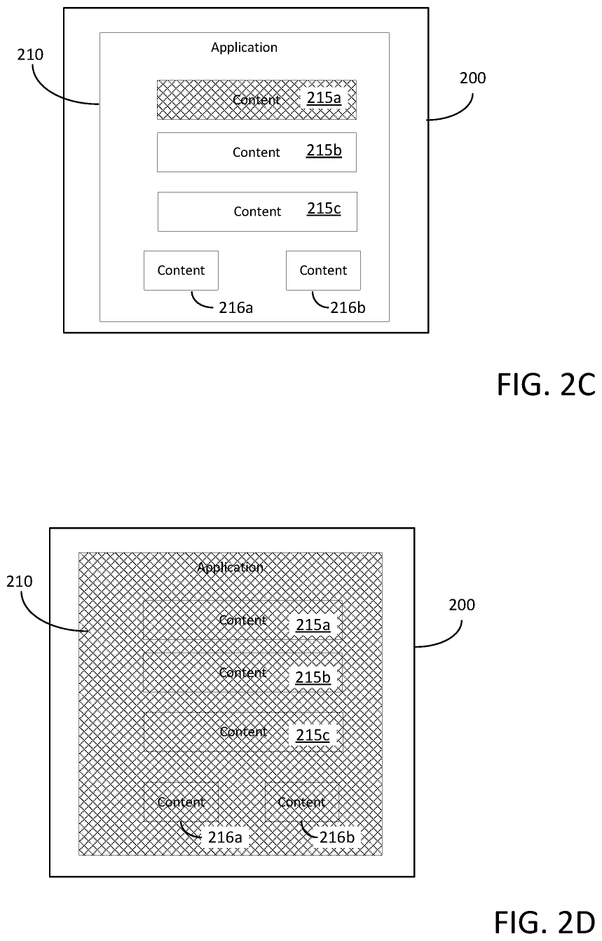

Additionally, the privacy application 750 also detects when the user display 120 is shared to external displays. For example, the privacy application 750 detects when a video conferencing application running on the system 110 enters into a shared content mode. In any example where the privacy application 750 detects the system 110 is displaying any content viewable persons other than the user 101, the privacy application 750 enables masking sensitive information in any shared content as shown in FIGS. 2A-D, 3A-D, and 4A-B.

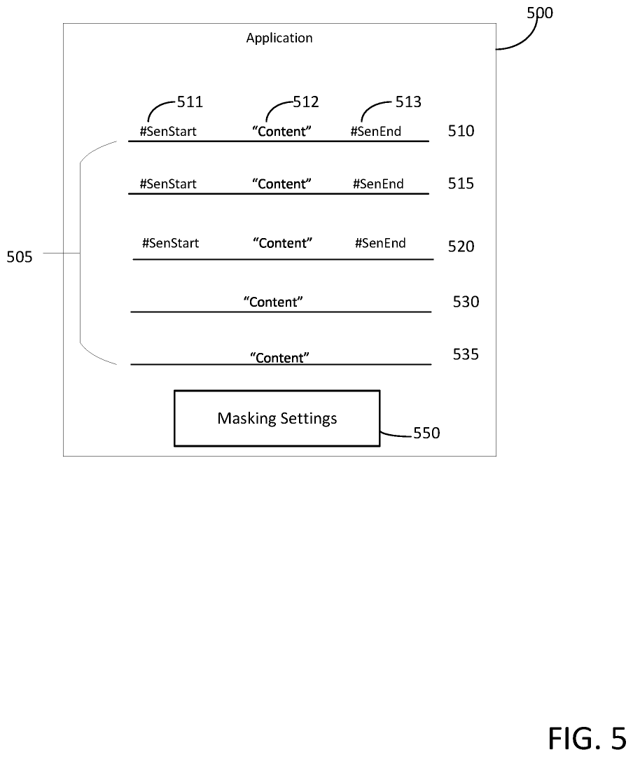

FIGS. 2A-D illustrates sensitive information in an application on shared displays, according to various embodiments. For example, display 200 shown in FIGS. 2A-2D includes an application 210 visually presented on the display 200. The display 200 may be any of the external displays 151a-151c and 160. The application 210 includes content items 215a-215c and 216a-216b. In some examples, content items 215a-215c include sensitive information that a user, such as the user 101, does not want displayed or viewable in any shared display. In some examples, the application 210 also includes content items that are not sensitive. For example, the content items 216a-b include content that is not sensitive or otherwise not marked private in the application 210. In some examples, sensitive information is identified by the privacy application 750 using various tags as described in relation to FIG. 5. According to various masking settings for the application 210, the privacy application 750 may mask or otherwise obscure the visual presentation of the content items 215a-c.

For example, in FIG. 2B, the content items 215a-c are visually obscured so that the information in the content items are not visible on the display 200. For example, none of the viewers 151a-c or 161a-b are able to observe the information in the content items 215a-c. In some examples, the content of the content items 215a-215c may include sensitive text which is replaced in the display 200 with random text, blacked out, or replaced with symbols such as an asterisk, such that the sensitive text is not viewable. In some examples, the content items 215a-215c may include images or other content, which is replaced by a blank image or an obscured version of the image. In each example, the masked content items prevent a viewer of the display 200 from ascertaining the sensitive information in the masked content item.

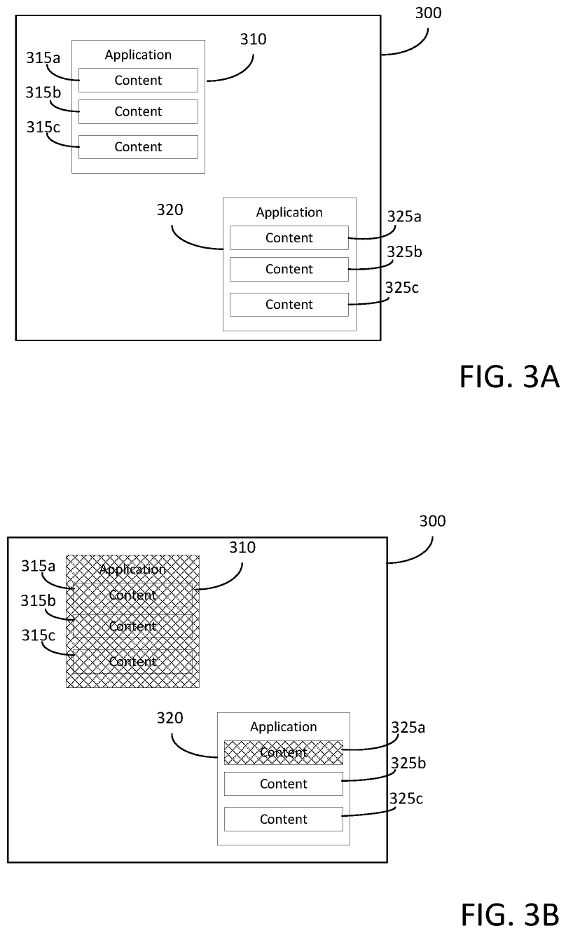

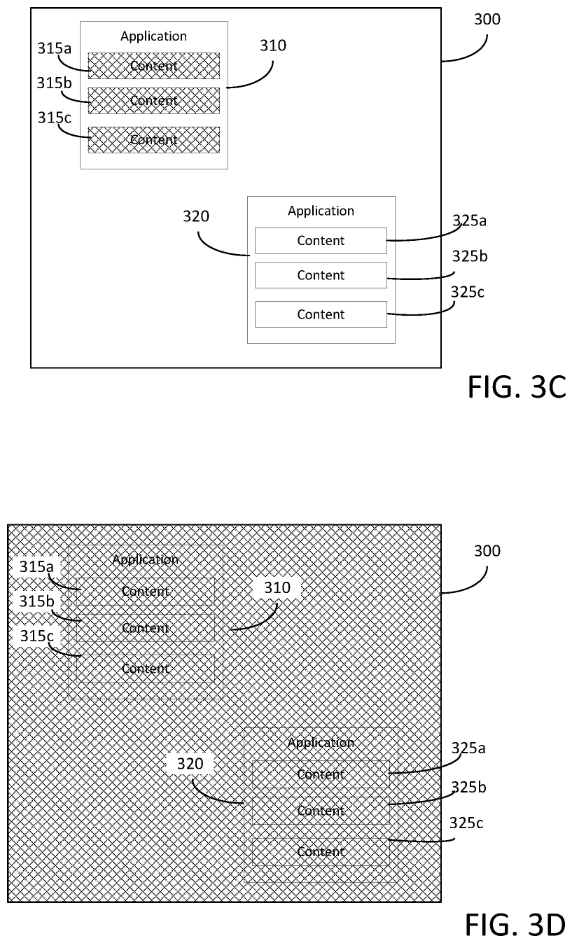

In another example, a subset of the content items may be marked for masking. For example, in FIG. 2C, only content item 215a is masked or visually obscured. In another example, the application settings may include settings to obscure the entire visual presented of the application as shown in FIG. 2D. In this example, the entire visual presentation of the application 210, including content items 215a-b and content items 216a-b without sensitive information, are masked or visually obscured. While the display 200 shown in FIGS. 2A-D all include a single application on the display, two or more applications with varying privacy settings and sensitive information may be displayed as shown in FIGS. 3A-D.

FIGS. 3A-D illustrates sensitive information in multiple applications on shared displays, according to various embodiments. For example, display 300 shown in FIGS. 3A-3D includes an application 310 and application 320 where both applications are visually presented on the display 300. The application 310 includes content items 315a-315c and the application 320 includes content items 325a-325c. In some examples, content items 315a-315c and 325a-325c include sensitive information the user 101 does not want displayed in the shared displays. In this example, the system 110 masks or obscures sensitive content or information according to various settings for the respective applications 310 and the user 101, for example, the system 110 may mask or otherwise obscure the visual presentation of the content items 215a-c.

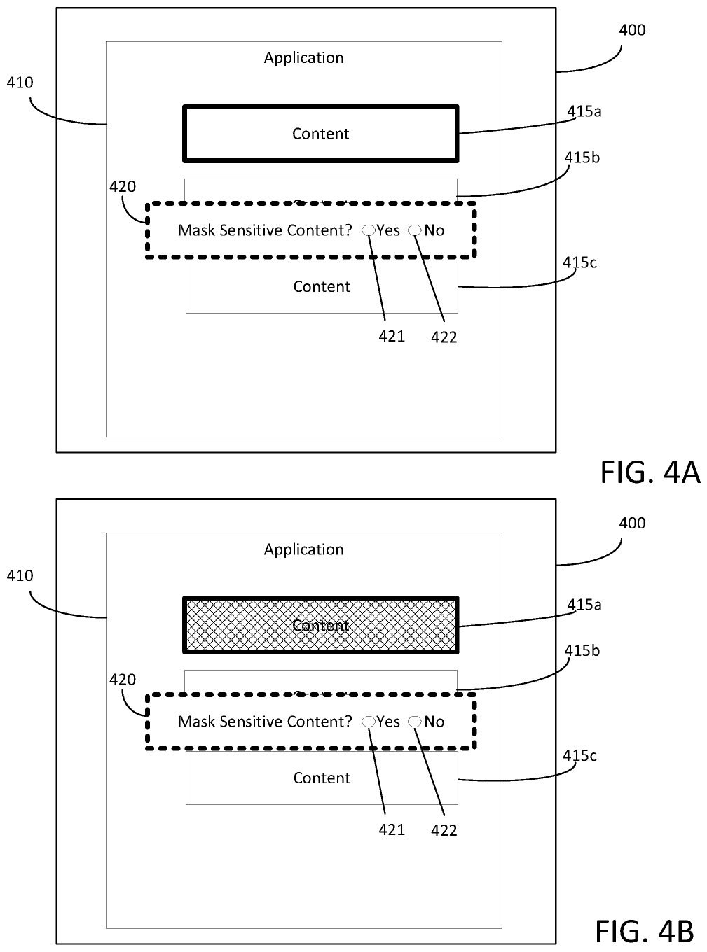

For example, in FIG. 3B, the entire visual presentation of application 310 is masked and only content item 325a is masked for the application 320. In another example, a subset of the content items may be marked for masking. For example, in FIG. 3C, content items 315a-315c are masked for application 310 and none of the content items 325a-325c are masked. In another example, the application settings for the application may include settings to obscure the entire visual presentation of the shared display as shown in FIG. 3D. In this example, the system 110 prevents any visual presentation of the application 310 or 320 from being viewed by the viewers 151a-c and 161a-c by masking the entire shared display 300. In some examples, the system 110 identifies marked sensitive information and masks the sensitive information automatically when either the user display, such as the user display 120, enters a shared condition or when the sensitive information appears on a display already in a shared condition. However, in some examples, the user 101 may not desire to have the sensitive information masked or obscured as described in relation to FIG. 4.

FIGS. 4A-B illustrates sensitive information on shared displays with a masking confirmation, according to various embodiments. For example, the display 400 shown in FIGS. 4A and 4B includes application 410 and associated content items 415a-415c. In some examples, at least content item 415a includes sensitive information. In some examples, the privacy application 750, prior to masking sensitive information in the display 120, confirms that masking of the sensitive information is desired from the user. For example, in some cases sensitive information is intended to be presented in a shared display to the 400. The system 110 provides an indication such as user interface element 420 which requests a confirmation from the user to mask sensitive content. In some examples, the element 420 includes selectable options 421 and 422 (e.g., yes or no).

In some examples, the user 101 intends to display the sensitive content to the viewers 111, 151a-c, and 161a-b. In this example, the users selects option 422 and the system 110 does not mask the content item 415a as shown in FIG. 4A. In another example, the user 101 does not intend to share sensitive information and selects option 421. The system 110, according to the user selection, masks the content items 415a as shown in FIG. 4B. In each of the examples, shown in FIGS. 2A-4B, the displays include content with sensitive information and non-sensitive information. In some examples, the system 110 determines the various levels of sensitive information according to tags within a structured application as shown in FIG. 5.

FIG. 5 illustrates an application with sensitive information tags, according to an embodiment. In some examples, application 500 is an application or program executing on the system 110 with a structure 505 for content items 510-535. When executing on the system 110, the application 500 displays visual representations of information and content on the user display 120 (and external displays 150a-c and 160a-c when in a shared display condition). FIG. 5 includes pseudocode for the application including a listing of various content for display. In some examples, the application 500 includes the content stored as strings, objects, calls to the content, or any other type appropriate elements in the structure 505.

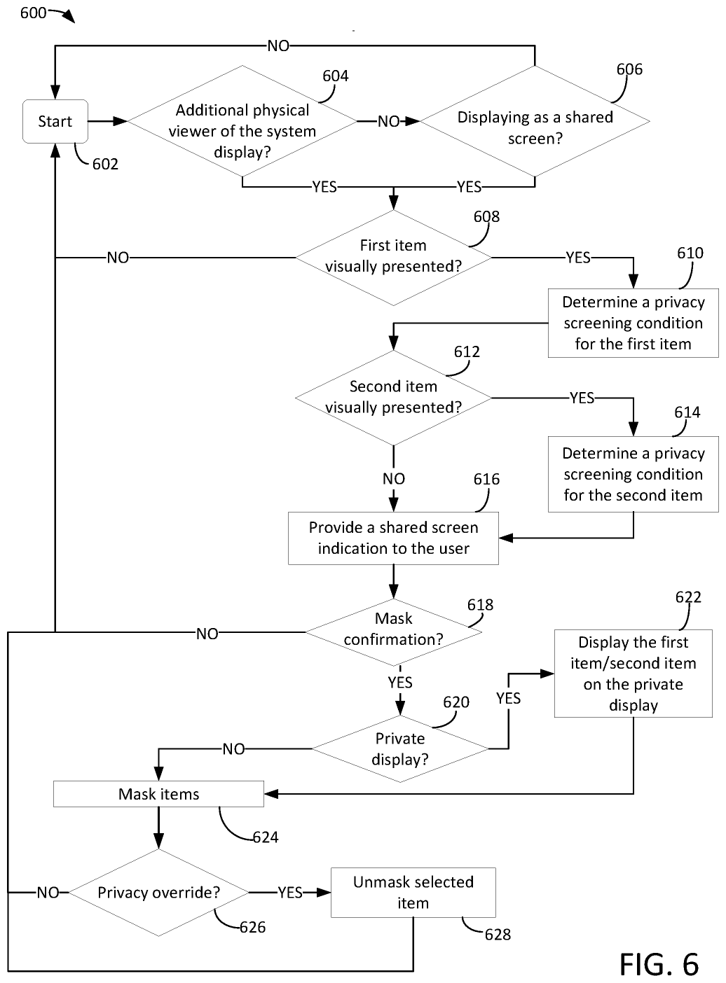

In some examples, the content items 510-535 includes tags 511 and 513 which indicate that content for display 512 is sensitive content. In some examples, upon receiving an indication from the privacy application 750 that the user display 120 is in a shared conditions, the system 110, including the application 500 utilizes the tags 511 and 513 to identify content items with sensitive information and masks the information according to masking settings 550. For example, the masking setting may indicate which of the content items are to be masked and a manner to obscure the visual representation (e.g., replace text, images, etc.). For example, the content 512 for display includes the visual elements (e.g., text, graphics, images, etc.) to be displayed and the application 500 and system 110 obscures the visual elements according to the masking settings 550. In some examples, the privacy application 750 detects and masks sensitive information in shared displays as described in more detail in relation to FIG. 6.

FIG. 6 is a method for masking sensitive information in a networked display system, according to embodiments described herein. For example, the system 110, including the privacy application 750, performs method 600 as described herein to detect a shared display condition and mask sensitive information or content. For ease of discussion, reference will be made to FIGS. 1-5 and 7 during discussion of the method 600. Method 600 begins at block 602 where the system 110 is in a steady state start condition pending the detection of a shared display. At blocks 604 and 606, the privacy application 750 of the system 110 detects whether a system display associated with a user is in a shared condition.

For example, at block 604, the privacy application 750 detects, using at least one presence sensor, whether at least one additional physical viewer is viewing a system display. For example, as shown in FIG. 1, the privacy application 750 using the sensor 115 detects the additional physical viewer 111. In another example where an additional physical view is not present, (e.g., the user 101 is alone or is the only person viewing the user display 120), the privacy application 750 determines there are no additional viewers. In an example where an additional physical viewer is not detected, method 600 proceeds to block 606. In an example, where an additional physical viewer (e.g., the viewer 111) is detected, the privacy application 750 determines the system display (e.g., user display 120), is in a shared condition and method 600 proceeds to block 608.

At block 606, the privacy application 750 determines whether a screen or content sharing application on the system is displaying contents presented on the display as a shared screen. For example, the privacy application 750 detects whether the user display 120 is mirrored or presented on any combination of the external displays 150a-c and 160. In an example where the user display 120 is not mirrored or presented as a shared screen, the privacy application 750 determines the user display 120 is not in a shared condition and method 600 returns to block 602. In an example where the user display 120 is mirrored or presented on any of the external displays 150a-c and 160 the method 600 proceeds to block 608. In some examples, upon detecting the user display 120 is in a shared condition, the privacy application 750 indicates to each application executing on the system 110 that the display is in the shared condition. For example, the privacy application 750 indicates that to applications 130a and 130b in FIG. 1 that the user display 120 is in the shared condition.

At block 608, the privacy application 750 determines whether a first item, including sensitive content and associated with a first application running on the system is visually presented on the display. For example, the privacy application 750 interacting with the application 500 in FIG. 5 identifies content items that are visually presented on the user display 120 including any of the content items 510-520 which include sensitive information. In some examples, when no application on the system 110 is presenting sensitive information on the display 120, method 600 returns to block 602.

In another example, the privacy application 750 may detect that the content item 510 is visually presented or will be visually present on the user display 120 by the application 500. In this example, method 600 proceeds to block 610, where the privacy application 750 determines from privacy settings for the first application a privacy screening condition for the first item. For example, the privacy application 750 interacts with the application 500 and the masking settings 550 to determine a manner in which the content item, such as the content item 510 is to be masked. For example, the content item 510 may be obscured according to any of the examples, shown in FIGS. 2A-3D.

At block 612, the privacy application 750 determines whether a second item associated with a second application running on the system is visually presented on the display. For example, the privacy application 750, interacting with the application 500 in FIG. 5, identifies additional content items that are visually presented on the user display 120 including any of the content items 510-520 which include sensitive information. The privacy application 750 may also interact with additional application similar to the application 500 in order to determine whether the additional application are also displaying content items with sensitive information on the user display 120. In this example, method 600 proceeds to block 614, where the privacy application 750 determines from privacy settings for the second application a privacy screening condition for the second item. For example, the privacy application 750 interacts with the application 500 and the masking settings 550 to determine a manner in which the content item, such as the content item 515 is to be masked.

In some examples, at block 616, the privacy application 750 provides an indication to the user indicating the system display is in a shared condition and requests a confirmation from the user to mask the first item at block 618. For example, as shown in FIGS. 4A-B, the privacy application 750 requests confirmation that sensitive information is to be masked. In an example where the user indicates that masking is not needed, method 600 proceeds back to block 602. In another example, when the privacy application 750 receiving masking confirmation from the user, method 600 proceeds to block 620.

At block 620, the privacy application 750 detects whether a private display is associated with the user. For example, the privacy application 750 detects an additional display such as the display 125 is available to the user. In some examples, an alternate private display may be available to the user such as a subsection of the user display 120. In some examples, any content presented on the private display is not mirror or displayed on the external displays 150a-c and 160. The private display also includes a mirrored presentation of the contents presented on the user display 120. In an example where a private display is available method 600 proceeds to block 622, where the privacy application 750 displays the first and second content items, and other content items, according to original display settings of the application on the private display. For example, the content items are presented without masking on the private display.

At block 624, the privacy application 750 interacting with the structured applications (e.g., the application 500) masks the first item, second item, and any additional sensitive information according to the respective privacy screening conditions to obscure the visual presentation of contents of items on the display in the shared condition. For example, the privacy application 750 obscures a visual presentation of all marked sensitive content, obscures a visual presentation of a subset of marked sensitive content, or obscures a visual presentation of all application content related to sensitive content as described in relation to FIGS. 2A-3D. In some examples, the application, such as the application 500, may provide the content for display without further processing from the privacy application 750. For example, upon receiving a notification that the display is in a shared condition, the application 500 itself masks sensitive information for presentation on the display 120. In another example, the privacy application 750 further processes content from the application 500 in order to mask the marked sensitive information prior to displaying the information on the display 120.

At block 626, the privacy application 750 determines whether a privacy override has been received from the user 101. For example, the user may indicate via a user interface element, such as the element 420 in FIGS. 4A and 4B, that the sensitive content should be unmasked or presented on the user display 120 (and the external displays 150a-c and 160). In one example, the privacy application 750 receives a privacy override request from the user and confirms from privacy settings for the first application the privacy override request is allowed for the first item. For example, the privacy application 750 may determine from the settings 550 that the sensitive content in the content item 510 is able to be unobscured or unmasked. In an example where a privacy override is not received or confirmed, method 600 proceeds back to block 602.

In an example, where a privacy override is confirmed, method 600 proceeds to block 628, where the privacy application 750 unmasks a content item to present the visual presentation of contents of on the display according to original display settings of the first application. For example, the privacy application 750 removed the masking from the content item 415a in FIG. 4B such that the content is presented without masking as shown in FIG. 4A.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 7 illustrates a block diagram of a system with a privacy application, according to one embodiment. Computing environment 700 contains an example of an environment for the execution of at least some of the computer code involved in performing the inventive methods, such as privacy application 750. In addition to privacy application 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and privacy application 750, as identified above), peripheral device set 714 (including user interface (UI) device set 723, storage 724, and Internet of Things (IOT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 1. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in privacy application 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in privacy application 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

While the foregoing is directed to embodiments of the present invention, other and further embodiments of the invention may be devised without departing from the basic scope thereof, and the scope thereof is determined by the claims that follow.

What is claimed is:

1. A method comprising:
detecting, at a privacy application for a system, a system display associated with a user is in a shared condition;
detecting a first item associated with a first application running on the system is visually presented on the system display;
determining from privacy settings for the first application a privacy screening condition for the first item; and
masking the first item according to the privacy screening condition to obscure the visual presentation of contents of first item on the system display in the shared condition.

2. The method of claim 1, wherein detecting the system display in a shared condition comprises:
detecting a screen sharing application on the system is displaying contents presented on the system display as a shared screen.

3. The method of claim 2, further comprising:
detecting a private display associated with the user;
wherein the system display in the shared condition comprises a mirrored presentation of the contents presented on the private display associated with the user;
where masking the first item according to the privacy screening condition comprises:
obscuring the visual presentation of contents of first item in the mirrored presentation of the contents presented on the system display in the shared condition; and
displaying the first item according to original display settings of the first application on the private display.

4. The method of claim 1, wherein detecting the system display in a shared condition comprises:
detecting, using at least one presence sensor, at least one additional physical viewer of the system display.

5. The method of claim 1, further comprising:
providing an indication to the user indicating the system display is in a shared condition;
requesting a confirmation from the user to mask the first item; and
masking the first item upon receiving the confirmation from the user.

6. The method of claim 1, further comprising:
detecting a second item associated with a second application running on the system is visually presented on the system display;
determining from privacy settings for the second application a privacy screening condition for the second item; and
displaying the second item according to original display settings of the second application.

7. The method of claim 1, further comprising:
receiving a privacy override request from the user;
confirming from privacy settings for the first application the privacy override request is allowed for the first item; and
unmasking the first item to present the visual presentation of contents of first item on the system display according to original display settings of the first application.

8. The method of claim 1, wherein privacy settings for the first application comprise one or more of:
obscuring a visual presentation of all sensitive content marked by the first application;
obscuring a visual presentation of a subset of sensitive content marked by the first application; and
obscuring a visual presentation of all application content related to the first application.

9. A system comprising:
a computer processor; and
a memory containing a program which when executed by the computer processor performs an operation comprising:
detecting, at a privacy application for a system, a system display associated with a user is in a shared condition;
detecting a first item associated with a first application running on the system is visually presented on the system display;
determining from privacy settings for the first application a privacy screening condition for the first item; and
masking the first item according to the privacy screening condition to obscure the visual presentation of contents of first item on the system display in the shared condition.

10. The system of claim 9, wherein the operation further comprises:
detecting a private display associated with the user;
wherein the system display in the shared condition comprises a mirrored presentation of the contents presented on the private display associated with the user;
where masking the first item according to the privacy screening condition comprises:
obscuring the visual presentation of contents of first item in the mirrored presentation of the contents presented on the system display in the shared condition; and
displaying the first item according to original display settings of the first application on the private display.

11. The system of claim 9, wherein detecting the system display in a shared condition comprises:
detecting, using at least one presence sensor, at least one additional physical viewer of the system display.

12. The system of claim 9, wherein the operation further comprises:
providing an indication to the user indicating the system display is in a shared condition;
requesting a confirmation from the user to mask the first item; and
masking the first item upon receiving the confirmation from the user.

13. The system of claim 9, wherein the operation further comprises:
detecting a second item associated with a second application running on the system is visually presented on the system display;
determining from privacy settings for the second application a privacy screening condition for the second item; and
displaying the second item according to original display settings of the second application.

14. The system of claim 9, wherein the operation further comprises:
receiving a privacy override request from the user;
confirming from privacy settings for the first application the privacy override request is allowed for the first item; and
unmasking the first item to present the visual presentation of contents of first item on the system display according to original display settings of the first application.

15. The system of claim 9, wherein the operation further comprises, wherein privacy settings for the first application comprise one or more of:
obscuring a visual presentation of all sensitive content marked by the first application;
obscuring a visual presentation of a subset of sensitive content marked by the first application; and
obscuring a visual presentation of all application content related to the first application.

16. A computer program product, the computer program product comprising:
a computer-readable storage medium having computer-readable program code embodied therewith, the computer-readable program code executable by one or more computer processors to perform an operation comprising:
detecting, at a privacy application for a system, a system display associated with a user is in a shared condition;
detecting a first item associated with a first application running on the system is visually presented on the system display;
determining from privacy settings for the first application a privacy screening condition for the first item; and
masking the first item according to the privacy screening condition to obscure the visual presentation of contents of first item on the system display in the shared condition.

17. The computer program product of claim 16, wherein the operation further comprises:
detecting a private display associated with the user;
wherein the system display in the shared condition comprises a mirrored presentation of the contents presented on the private display associated with the user;
where masking the first item according to the privacy screening condition comprises:
obscuring the visual presentation of contents of first item in the mirrored presentation of the contents presented on the system display in the shared condition; and
displaying the first item according to original display settings of the first application on the private display.

18. The computer program product of claim 16, wherein the operation further comprises:
providing an indication to the user indicating the system display is in a shared condition;
requesting a confirmation from the user to mask the first item; and
masking the first item upon receiving the confirmation from the user.

19. The computer program product of claim 16, wherein the operation further comprises:
detecting a second item associated with a second application running on the system is visually presented on the system display;
determining from privacy settings for the second application a privacy screening condition for the second item; and
displaying the second item according to original display settings of the second application.

20. The computer program product of claim 16, wherein the operation further comprises:
wherein privacy settings for the first application comprise one or more of:
obscuring a visual presentation of all sensitive content marked by the first application;
obscuring a visual presentation of a subset of sensitive content marked by the first application; and
obscuring a visual presentation of all application content related to the first application.
